(19) United States
(12) Patent Application Publication
(10) Pub. No.: US 2005/0030189 A1
(43) Pub. Date: Feb. 10, 2005

(54) Device for celestial object location relative to a user's gaze or its approximation

(75) Inventor: William Roland Foster, Wilmington, DE (US)

Correspondence Address: WILLIAM R. FOSTER, 1414 WOOD LAWN AVE, WILMINGTON, DE, 19806, US

(73) Assignee: William Roland Foster, Wilmington, DE (US)

(21) Appl. No.: 10/604,645

(22) Filed: Aug. 6, 2003

(51) Int. Cl. G08B 21/00

(52) U.S. Cl. 340/686.1; 340/999; 359/430; 33/268

(57) ABSTRACT

A device wearable or external to a user that determines and communicates what celestial objects a user's gaze or its approximation is directed at or near. The device is useful for guiding a user's gaze to a celestial object of interest or informing a user what objects their gaze or its approximation is directed towards or near. The device uses sensors to detect or approximate a user's gaze, a computer processor, computer memory, input/output devices, time keeping, software, a database of celestial objects with associated facts of interest, and a database of geographical objects with associated latitude and longitude.

### BACKGROUND OF INVENTION

The invention relates to astronomy, more particularly the identification of celestial objects in relation to a user's gaze.

There is considerable prior art related to using computers, time keeping, and databases to aid a user in locating a celestial object either with their eyes by comparison with a display (e.g. U.S. Pat. No. 5,704,653), with a handheld non-telescopic device by pointing or looking through (e.g. U.S. Pat. No. 6,366,212), or by the use of telescopes (e.g. U.S. Pat. No. 6,392,799). This prior art does not enable the a user of the device to simply look towards a region of the sky and have the celestial objects known to be in the direction of gaze identified (based on the sensed or estimated direction of gaze, the known coordinates of the celestial objects, and the known time and location of use).

### SUMMARY OF INVENTION

This invention allows a user's gaze to be related to the location of celestial objects in the sky. The user's gaze may be measured directly by sensors aimed at the user's eyes (e.g. as with infrared light reflected from a user's eye as in inventions like U.S. Pat. No. 5,600,400) or imputed by measuring the user's body position in space and assuming the gaze to be straight ahead from the user's face or even by a combination of body sensing and gaze sensing. The measurement of the user's body position can be with respect to earth's gravitational and magnetic fields as determined by acceleration and magnetism sensitive sensors placed at locations on the body. The determination of what objects are within a user's gaze, or are in a specific direction relative to a user's gaze, or are at a given angular distance from the user's gaze is performed using standard astronomical calculations making use of gaze direction, time, position on the earth's surface, and the known coordinates of celestial objects. The various components that comprise the invention (sensors, processor, database of geographic locations with associated latitude and longitude, database of celestial object locations with any additional facts of interest about these objects, input/output devices, time keeping, and power sources) may be distributed in space and interconnected to allow communication either by a conductor, conductive medium, or by electromagnetic signals, or sound signals.

In all embodiments of the invention the user's gaze is sensed directly or is approximated by the sensing of the user's body position and assuming a relationship of gaze to body position. Some methods of sensing involve significant cost and complexity such as the use of an array of cameras to view the user's eye position, or the use of multiple, highly accurate gyroscopes to assess the user's body position, or the creation of a local frame of reference for the user's body relative to surroundings by the use of light and ultrasound signals. Given the current state of the art of sensor cost and size, a currently economically practical embodiment is to use a multi-axis accelerometer placed on the user's head (perhaps within a hat worn by the user) and a multi-axis magnetometer placed on the user's waist (perhaps clipped over pants or a belt).

In all embodiments, the invention must provide communication with the user. The inputs to the device from the user may be via buttons or by voice command. The outputs to the user may be by alphanumeric display, graphic display, speakers, or vibration.

In all embodiments, the invention must perform computations to relate a user's gaze or approximated gaze to celestial objects according to formulas that are well known in astronomy. Computations are also performed to communicate with sensors, databases, time keeping, and input/output devices. In a currently economic embodiment this computation can be performed by a microprocessor such as those sold by Microchip Technology Inc or Motorolla, Inc.

In all embodiments the time at which a user's gaze has a specific direction relative to the sky must be determined. This may be done by receiving a time signal from a radio station or satellite or it may be done by having the user input the current time when they start the device and then incrementing the time with a time keeping device such as a microcontroller or real time clock chip.

In all embodiments the location of use must be provided in latitude and longitude or a measure transformable into latitude and longitude. The latitude and longitude may be determined by the use of global positioning signals or may be obtained by having the user input location of use into the device. The latitude and longitude may be approximated by that of a big city, or that of the center of a state, province, country, or postal code region in which case the user can enter into the device or select from a menu the name of a city, state, province, country, or postal code and the device will look up an associated latitude and longitude from computer memory.

In all embodiments information must be stored. This storage may be in a variety of commercially available formats including those supplied with a microprocessor. The information stored may be text, sounds, pictures, numbers, or software. In one embodiment addressed sound clips are stored in chipcorder chips available from Winbond Electronics Corporation America. In some embodiments information is stored on removable media which may be updated from a personal computer and then placed into the device, as is the current practice with memory cards into digital mp3 players.

In all embodiments components must receive power. This power may be supplied by a battery that feeds power through wires to each component of the device or it may be supplied by multiple batteries in components that are physically separate. In one possible embodiment power is generated from mechanical energy supplied by the user and this power is distributed to device components through conductors.

In all embodiments there is a database of celestial objects, their names, locations and associated information (any or all of: scientific, historical, or fictional information stored so as to be presented to the user via any combination of graphical, textual, sound, or vibrational signals). The celestial objects may be any astronomical object: stars, star groupings, planets, moons, asteroids, comets, artificial satellites, galaxies, novae, or nebula. In one embodiment the database consists of constellation names and locations stored in text and associated facts stored as sound clips. In another embodiment only planets and constellations are represented in the database. In another embodiment the user may add an object to the database through an input device or may update the database via connecting the device to a network or updated removable memory.

In all embodiments it is envisioned that there is a sequence of steps that occur once the device is powered on and prior to the device being used to identify or locate celestial objects. These initialization steps may include self tests. Initialization may include setting or calibrating the sensors of the device, which may in turn require that the user gaze in set directions or ways while sensor readings are being taken. For instance, in one embodiment the signals from accelerometers are initially read while the user looks straight ahead and approximately level to the earth's surface. In some embodiments a user rotates a full 360 degrees as readings from the magnetometer are taken to assess the presence of soft or hard iron defects. In some embodiments temperature is measured so that its effects on sensors may be estimated. In some embodiments a user is able to re-run initialization procedures as desired or to adjust the relationship of sensor measurements with celestial objects by means of gazing at a known celestial object.

### BRIEF DESCRIPTION OF DRAWINGS

FIG. 1. Overall schematic of the invention showing components necessary in all embodiments. The arrows denote connections that depending on the embodiment could be a combination of conductors, electromagnetic signals, sound signals, or vibration.

FIG. 2. Example compositions of components in some potential embodiments of the invention. The arrows denote connectivity, which for signals could be wire, a conductive media, electromagnetic signals, sound signals, or vibration. The multiple arrows from power sources to the components denote a multiplicity of potential connections, being perhaps connections to all components from a single power supply or connections from power sources distributed near each component.

FIG. 3 shows an embodiment of the invention where gaze is approximated by the user's body position relative to earth's gravitational and magnetic field and separate components are connected by a conductor. In this embodiment a multi-axis accelerometer (B) is attached to or is within a hat worn by the user. A multi-axis magnetometer (C) is attached to the waist of the user and a housing (A) containing a processor, memory, time keeping components, batteries, speaker, alphanumeric display, and keypad is held by the user. Components are interconnected by wire (D). The user's gaze denoted by the dotted line (E) is directed towards a grouping of stars, a grouping that could have a name, location, and other information stored about it in the device's database.

FIG. 4 same configuration as in FIG. 3, but the multi-axis accelerometer and multi-axis magnetometer have their own battery power and send signals to the handheld housing via electromagnetic signals so that the conductors of FIG. 3 are not needed. The remaining labels are the same as those of FIG. 3.

FIG. 5 shows a flow diagram for the operation of the device. The first two items represent start up procedures of determining time and location and of checking/calibrating sensors. Following these, the user then selects whether they wish to seek a specific object or to have objects near where they gaze identified to them. If the former, then the left side of the flow is followed; if the later, then the right hand flow is followed. Following an object being reached or identified, the flow can start over again at mode selection or at calibration should errors be obvious to the user.

### DETAILED DESCRIPTION

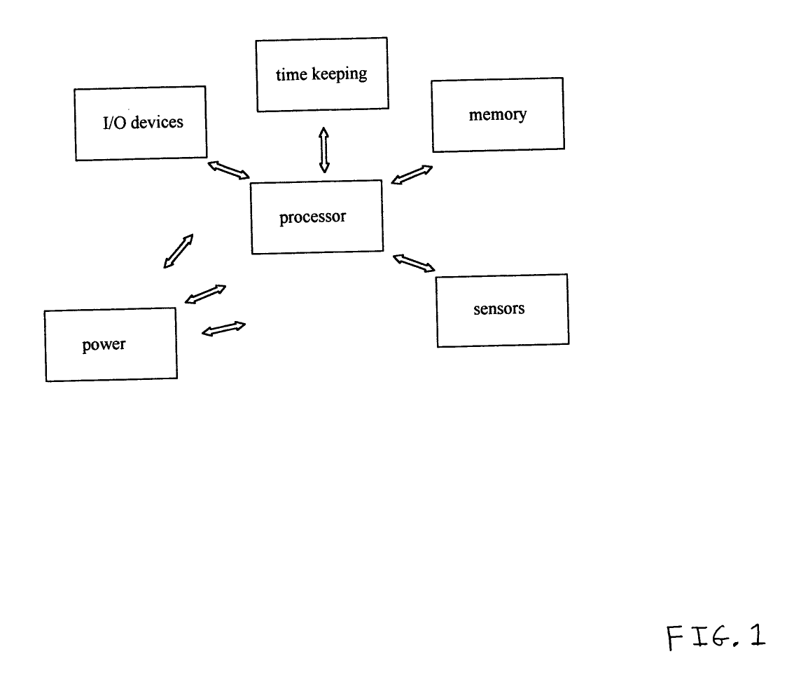

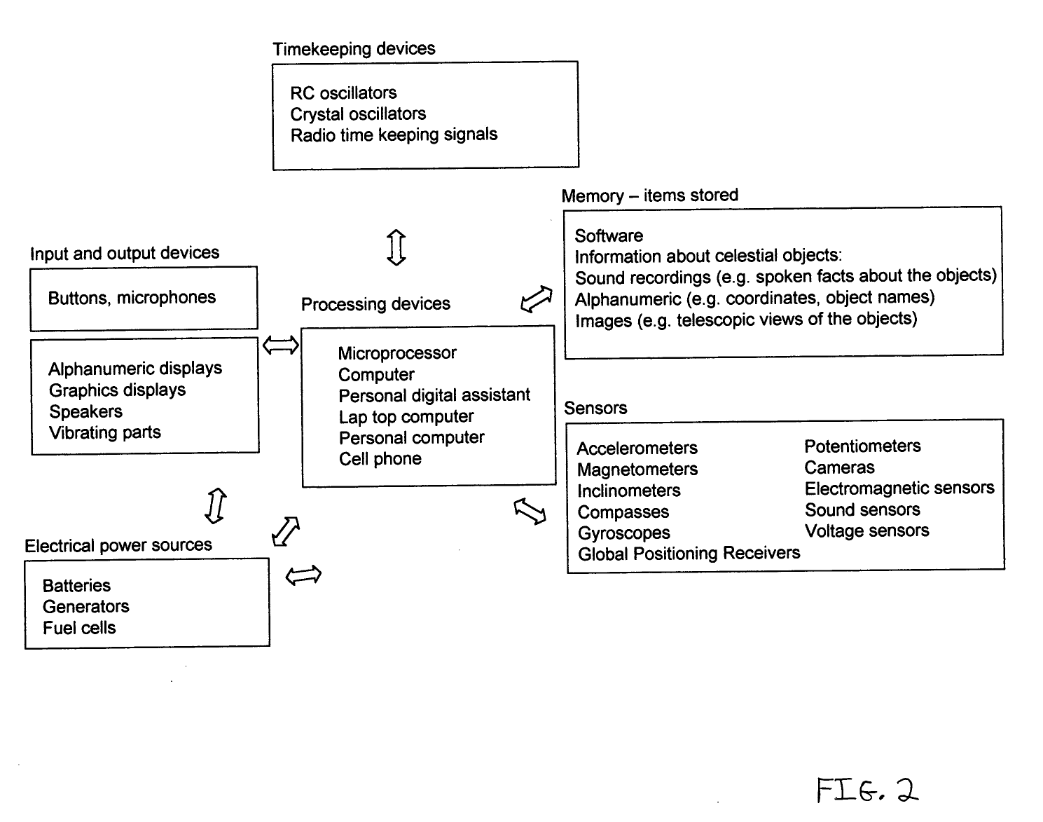

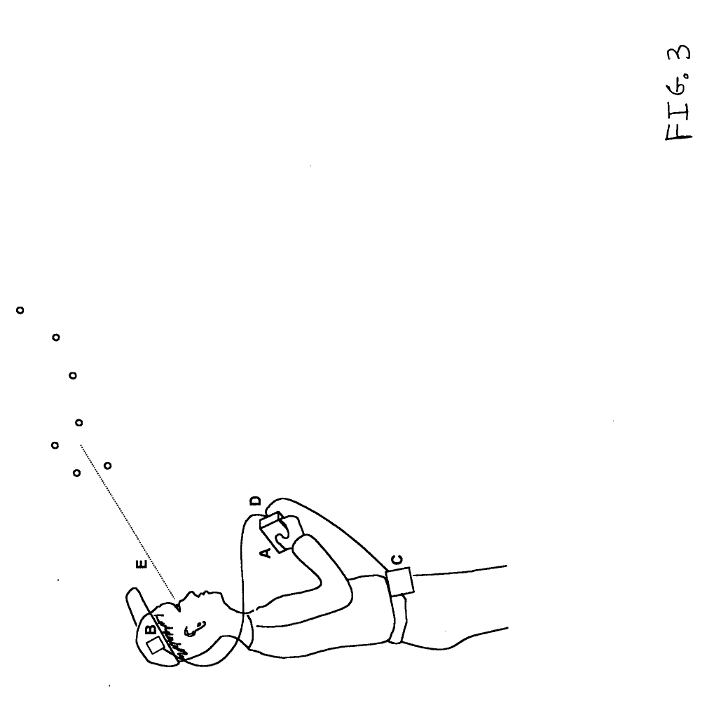

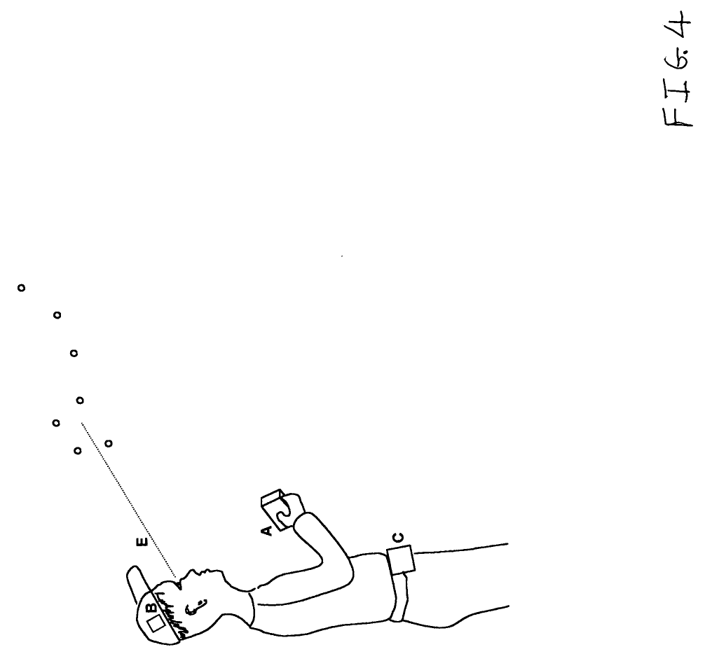

This detailed description is of the currently preferred embodiments of the invention and are meant to be illustrative of the invention. FIG. 1 provides a schematic of the necessary components of the invention. FIG. 2 provides some possible embodiments of these necessary components. FIG. 3 is a still further restricted embodiment of the invention focusing on specific kinds of sensors (the use of accelerometers and magnetometers), placements of these sensors (on the user's head and waist) and method of interconnecting physically separate components (by wire). FIG. 4 provides another embodiment where the device of FIG. 3 has signals carried from sensors to the processor via electromagnetic signals instead of wires. Though not shown a potential embodiment is to have the sensors of FIG. 4 or FIG. 3 both be placed on the user's head.

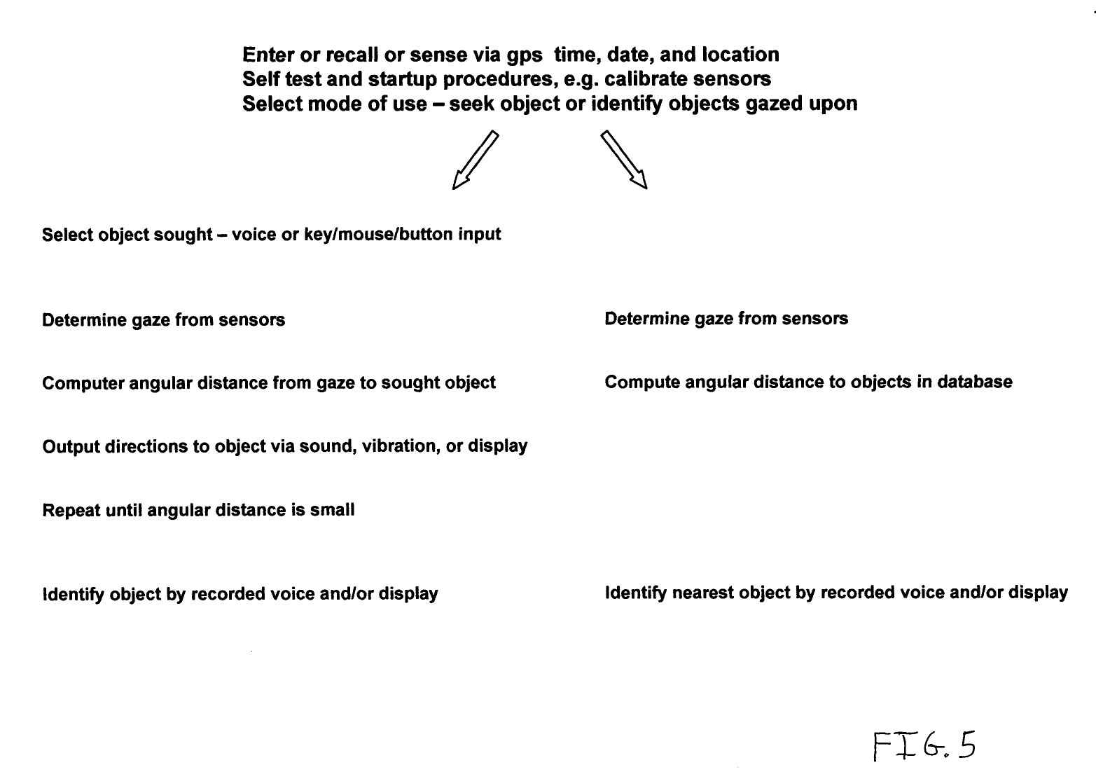

The device of FIG. 3 or 4 would operate according to the flow diagram of FIG. 5. The user would turn on the device and enter location and time information (in some embodiments prior entries may be saved in memory and could become default values). After this the user would be prompted to assist in the initialization of the sensor readings by gazing at some standard positions (in some embodiments straight ahead and straight up). Following initialization the user can select from two methods of use and repeat these as desired. The first method of use is to select an object from a set of choices appearing in the display of the device using buttons or keypad. The device would then indicate to the user by sounds which direction to look to find the selected object. The device could do this by voice or by a tone or vibration that varied with angular proximity of computed gaze to the celestial object sought. Once the user's gaze was at the sought object, facts about this object would be communicated to the user by the device via speaker or display. A second method of use is for the user to simply look around the sky. As objects are encountered by the user's gaze, the device indicates the name of the object being viewed. If more information is desired about this object, the user can indicate this by voice or button input into the device.

1. A device for identifying or approximating the celestial objects a user's gaze is directed to or near and for indicating that information to the user comprising:
A means of detecting or approximating a user's gaze.
A processing device, such as a microprocessor that receives and manipulates information from sensors, and input devices, performs calculations required to determine a user's gaze relative to celestial objects, retrieves information from memory about celestial objects, and outputs information to the user.
An input device such as a handheld keypad or a microphone for voice input.
Output devices such as graphical displays and speakers.
A database of celestial objects, their names, celestial coordinates, and any other information of potential use or interest such as historical, scientific, or fictional information about the objects.
A database of geographic locations and associated latitude and longitude.
A means of time keeping.
A power supply.
Interconnections between physically distinct components for information flows and in some embodiments power flows.
Software for directing the processor to interact with input/output, databases, sensors to fulfill the devices design goal.

2. The device of claim 1 where the direction of the user's gaze is approximated by the position of their head and body relative to the earth's magnetic and gravitational fields as determined by sensors on the head and on or attached to the body.

3. The device of claim 1 where a user's gaze is approximated by the position of their head relative to the earth's magnetic and gravitational fields as determined by sensors.

4. The device of claim 1 where a user's gaze is approximated by the angle of inclination of the user's head with respect to the earth's gravitational field and of the user's body with respect to the earths magnetic field as determined by sensors.

5. The device of claim 4 where the angle of inclination of the user's head is determined by accelerometers, either 1,2, or 3 axis and the direction of the user's body is determined by magnetometers of 2 or 3 axis design.

6. The device of claim 1 where a user's gaze is approximated by the position of their head relative to a reference direction maintained by a gyroscope or gyroscopes.

7. The device of claim 1 where a user's gaze is approximated by the position of their head relative to the earth's surface as determined by a gyroscope and relative to the earth's magnetic field as determined by a magnetometer.

8. The device of claim 1 where the user's gaze is determined by sensing the direction a user's eye is pointed and how the user's head is oriented relative to the earth's gravitational and magnetic fields.

9. The device of claim 1 where the user's gaze is determined by sensing the direction a user's eye is pointed and how the user's head is oriented relative to a reference direction maintained by a gyroscope or gyroscopes.

10. The device of claims 1-9 where sensors are embedded in clothing, such as hats.

11. The device of claims 1-9 where sensors or components are worn or attached to clothing or to the body.

12. The device of claim 1 where physically distinct components such as sensors, input/output, and computational devices are interconnected by any of or any combination of: wires, electromagnetic signals, or acoustic signals.

13. The device of claim 1 where the location of the device is determined by global positioning system signals.

14. The device of claim 1 where time is determined by receiving time signals from a radio station.

15. The device of claim 1 where a means of time keeping is via crystal oscillators attached to electronics as in microprocessors or real time clocks.

16. The device of claim 1 where location information, time at power on, and celestial objects being sought are all input via a handheld keypad.

17. The device of claim 1 where database of geographic locations consists of objects likely to be familiar to the user such as states, provinces, countries, big cities, lakes, addresses, or postal codes.

18. The device of claim 1 where database of celestial objects may be data in any useful format or combination of formats such as voice, text, or pictures.

19. The device of claim 1 where database of celestial objects may contain any information of use to approximating the object location (e.g. angular size) or of potential interest to the user including scientific, historical, cultural, or even fictional information.

20. The device of claim 1 where input whether of time, location, or celestial object being sought is entered by voice commands.

21. The device of claim 1 where output to the user is via any of or any combination of sound, vibration, images, or text.

22. The device of claim 1 that includes calibration steps, such as having the user hold their gaze horizontal and stand vertically so as to associate sensor readings with a standard position. These calibration steps could include obtaining sensor readings while facing to true north, looking to a known celestial object, doing a complete turn around a point, holding still, looking as high up in the sky as possible, or any other physical motion of positioning the head, body, or eyes so that sensor readings may be associated with these movements and positions.

23. The device of claim 1 where the processor is a personal computer communicating with the other components via electromagnetic signals, such as by a wireless networking protocol.

24. The device of claim 1 where the power supply may be from mechanical energy supplied by the user in place of batteries.

25. The device of claim 1 where the database of locations, objects, and also the software to control the device is downloaded into a separate storage device such as those used currently in digital cameras and mp3 players.
